(19) United States
(12) Patent Application Publication
(10) Pub. No.: US 2008/0144891 A1
(43) Pub. Date: Jun. 19, 2008

(54) Method and apparatus for calculating similarity of face image, method and apparatus for retrieving face image, and method of synthesizing face image

(75) Inventors: Won-jun Hwang, Seoul (KR); Eui-hyeon Hwang, Goyang-si (KR); Young-su Moon, Seoul (KR); Gyu-Tae Park, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/882,714

(22) Filed: Aug. 3, 2007

(30) Foreign Application Priority Data
Dec. 18, 2006 (KR) 10-2006-0129680

(51) Int. Cl. G06K 9/00

(52) U.S. Cl. 382/118

(57) ABSTRACT

A method and apparatus for calculating a similarity of a face image, a method and apparatus for retrieving a face image by using the calculation method and apparatus, and a method of synthesizing a face image are provided. According to the methods and apparatuses, by separately calculating a holistic similarity of a face image based on a holistic feature of the face image, and a local similarity of a face image based on local features of the face image, and adding the calculated similarity results according to weights, thereby calculating the similarity between compared face images, the similarity calculation result of the face considering both the holistic feature and local features of the face image can be obtained, thereby improving reliability of the face image similarity calculation and lowering complexity of the calculation.

### CROSS-REFERENCE TO RELATED PATENT APPLICATIONS

This application claims the benefit of Korean Patent Application No. 10-2006-0129680, filed on Dec. 18, 2006, in the Korean Intellectual Property Office, the disclosure of which is incorporated herein in its entirety by reference.

### BACKGROUND OF THE INVENTION

1. Field of the Invention

The present invention relates to a method and apparatus for calculating a similarity of a face image, a method and apparatus for retrieving a face image by using the method and apparatus for calculating the similarity, and a method of synthesizing a face image, and more particularly, to a method and apparatus for calculating a similarity between face images by extracting holistic feature vectors and local feature vectors from face images.

2. Description of the Related Art

As the frequency of terrorist attacks and information theft has recently increased, the importance of a face recognition system that is a countermeasure for preventing these incidents has increased even more. An efficient algorithm for calculating a similarity between face images is one of most important issues in the face recognition system.

Conventional methods of calculating a face similarity includes a principal components analysis (PCA) technique. The PCA technique is a method which uses holistic face features, thereby comparing a similarity of a face. When the PCA technique is used, the similarity calculation result may vary according to the hairstyle or contour of a face, thereby causing a problem.

Meanwhile, a linear discriminant analysis (LDA) technique is a method of finding a combination of features capable of classifying two or more classes more accurately. According to the LDA technique, a linear combination of variables that can maximize the difference between features of groups is derived, and by considering how groups are arranged according to a new variable, based on this linear combination, a weight allocated to each variable is readjusted. In this way, a combination of features capable of classifying two or more classes more accurately is found.

When a similarity between face images is calculated by using this LDA technique, the similarity values between face images belonging to different classes, respectively, show a distribution concentrated at a very low value due to the characteristic of the LDA method. Accordingly, it is difficult to utilize the LDA method in order to identify the degree of similarity between face images belonging to different classes.

### SUMMARY OF THE INVENTION

The present invention provides a method and apparatus for determining a similarity of a face image in which both the holistic features and local features of a face image are reflected in the result of the similarity determination, thereby improving the reliability of the face image similarity calculation, and lowering the complexity thereof, a method of and apparatus for retrieving a face image by using the similarity determination method and apparatus, and a method of synthesizing a face image.

According to an aspect of the present invention, there is provided a method of calculating a similarity of a face image, including: projecting an input face image onto a first basis related to the whole region of a face extracted from a training face image set, and generating a holistic feature vector of the input face image; projecting the input face image onto a second basis related to a local region of a face extracted from the training face image set, and generating a local feature vector of the input face image; and calculating a similarity between a training face image selected from the training face image set and the input face image, by using the holistic feature vector and the local feature vector of the training face image and the generated holistic feature vector and local feature vector of input face image.

According to another aspect of the present invention, there is provided a method of calculating a similarity of a face image including: extracting a first basis related to the whole region of a face from a training face image set; extracting a second basis related to a local region of a face from the training face image set; projecting an input face image onto the first basis, thereby generating a holistic feature vector of the input face image; projecting the input face image onto the second basis, thereby generating a local feature vector of the input face image; projecting any one training face image selected from the training face image set, onto the first basis, thereby generating a local feature vector of the selected training face image; projecting the selected training face image onto the second basis, thereby generating a local feature vector of the selected training face image; comparing the holistic feature vector of the input face image with the holistic feature vector of the selected training face image; comparing the local feature vector of the input face image with the local feature vector of the selected training face image; and calculating a similarity between the input face image and the selected training face image, by using the comparison results.

According to still another aspect of the present invention, there is provided a computer readable recording medium having embodied thereon a computer program for executing the method of calculating a similarity of a face image.

According to another aspect of the present invention, there is provided an apparatus for calculating a similarity of a face image, including: a reception unit receiving an input face image; a holistic feature generating unit projecting the input face image onto a first basis related to the whole region of a face extracted from a training face image set, and generating a holistic feature vector of the input face image; a local feature generating unit projecting the input face image onto a second basis related to a local region of a face extracted from the training face image set, and generating a local feature vector of the input face image; and a similarity calculating unit calculating a similarity between a training face image selected from the training face image set and the input face image, by using the holistic feature vector and the local feature vector of the training face image and the generated holistic feature vector and local feature vector of the input face image.

According to another aspect of the present invention, there is provided a method of retrieving a face image including: projecting an input face image onto a first basis related to the whole region of a face extracted from a training face image set, and generating a holistic feature vector of the input face image; projecting the input face image onto a second basis related to a local region of a face extracted from the training face image set, and generating a local feature vector of the input face image; and retrieving a face image from the training face image set, by using the generated holistic feature vector and local feature vector, the face image having a predetermined similarity with the input face image.

According to another aspect of the present invention, there is provided an apparatus for retrieving a face image including: a holistic feature generating unit projecting an input face image onto a first basis related to the whole region of a face extracted from a training face image set, and generating a holistic feature vector of the input face image; a local feature generating unit projecting the input face image onto a second basis related to a local region of a face extracted from the training face image set, and generating a local feature vector of the input face image; and a retrieval unit retrieving a face image having a predetermined similarity with the input face image, from the training face image set, by using the holistic feature vector and the local feature vector of the input face image.

According to another aspect of the present invention, there is provided a method of synthesizing a face image including: selecting two or more face images for synthesizing a face; extracting a holistic feature vector and a local feature vector from each of the selected face images; restoring a face image vector based on the holistic feature, by using the holistic feature vector extracted from each of the selected face images; restoring a face image vector based on the local feature, by using the local feature vector extracted from each of the selected face images; and synthesizing the restored face image vectors.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for calculating a similarity of a face image according to an embodiment of the present invention;

FIG. 2 is a flowchart of a method of calculating a similarity of a face image according to an embodiment of the present invention;

FIG. 3 is a detailed flowchart of generating a holistic feature vector, as illustrated in FIG. 2, according to an embodiment of the present invention;

FIG. 4 is a diagram illustrating an example of an image based on an eigenvector matrix, as illustrated in FIG. 3, according to an embodiment of the present invention;

FIG. 5 is a detailed flowchart of generating a local feature vector, as illustrated in FIG. 2, according to an embodiment of the present invention;

FIG. 6 is a diagram illustrating an example of an image based on a kernel matrix, as illustrated in FIG. 5, according to an embodiment of the present invention;

FIG. 7A is a diagram illustrating an example in which the eye region in a face image is selected as a local region according to an embodiment of the present invention, and FIG. 7B illustrates an example of weights with respect to each pixel according to an embodiment of the present invention;

FIG. 8 is a block diagram illustrating an apparatus for retrieving a face image according to an embodiment of the present invention;

FIGS. 9A and 9B are a flowchart of a method of retrieving a face image according to an embodiment of the present invention;

FIG. 10 is a block diagram illustrating an apparatus for synthesizing a face image according to an embodiment of the present invention; and

FIG. 11 is a flowchart of a method of synthesizing a face image according to an embodiment of the present invention.

### DETAILED DESCRIPTION OF THE INVENTION

The present invention will now be described more fully with reference to the accompanying drawings, in which exemplary embodiments of the invention are shown.

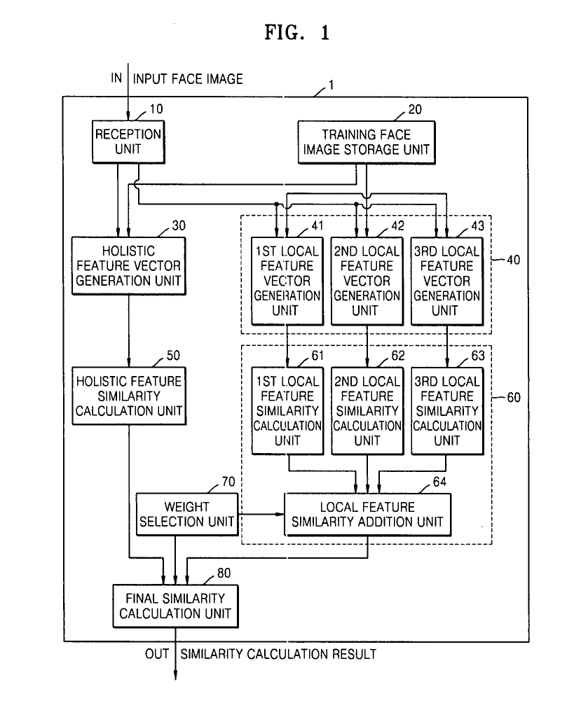

FIG. 1 is a block diagram of an apparatus 1 for calculating a similarity of a face image according to an embodiment of the present invention.

The apparatus 1 for calculating a similarity of a face image according to the current embodiment is composed of a reception unit 10, a training face image storage unit 20, a holistic feature generating unit 30, a local feature generating unit 40, a holistic feature similarity calculation unit 50, a local feature similarity calculation unit 60, a weight selection unit 70, and a final similarity calculating unit 80.

The reception unit 10 receives an input face image for calculating a similarity of a face image. The received input face image can be obtained by using an image acquisition apparatus capable of obtaining a face image, such as a camera or a camcorder.

The input face image, which is obtained by the reception unit 10, may be normalized by a predetermined preprocessing unit (not shown). The normalizing process includes removing the background image from the input face image, filtering the face image through a Gaussian low pass filter, and then, finding an eye region from the filtered image, normalizing the image with reference to the position of the eyes, and changing illumination, thereby removing dispersion of the illumination.

The training face image storage unit 20 stores information on a set of training face images. The training face image set is composed of a plurality of training face images. The current embodiment discloses an example of extracting holistic feature vectors and local feature vectors of training face images by using the holistic feature vector generating unit 30 and the local feature vector generating unit 40 which will be described below.

Unlike in the current embodiment, principal components analysis (PCA) and local feature analysis (LFA) of training face images may also be performed in advance, thereby establishing a database (DB) of holistic feature vectors and local feature vectors of each training face image extracted by using the PCA and LFA. In this way, a system that does not need a process of extracting feature vectors from training face images can also be implemented.

By projecting each of the input face image and a training face image onto a PCA basis (a first basis), the holistic feature vector generating unit 30 generates holistic feature vectors with respect to the holistic facial features.

Here, the PCA basis is an eigenvector for the whole face region, and is generated by performing PCA on training face images. A method of performing PCA and a method of obtaining a PCA basis will be described later.

By projecting each of the input face image and the training face image onto an LFA basis (a second basis), the local feature vector generating unit 40 generates local feature vectors with respect to the local facial features. Here, the LFA basis is generated by performing LFA on training face images. The LFA basis is a vector for extracting features of local regions of a face. A method of performing LFA and a method of obtaining an LFA basis will be described later.

The local feature vector generated by the local feature vector generating unit 40 is a feature vector reflecting features of a predetermined region of a face.

In the current embodiment, the local regions of a face indicate an area centered at the eyes, an area centered at the nose, and an area centered at the mouth. Here, a local feature vector means a feature vector which is extracted from a whole face region by placing a relatively large weight on the selected predetermined regions, such as eye, nose, and mouth regions, and does not mean a feature vector extracted from only one of the selected predetermined regions.

The local feature vector generating unit 40 is composed of a first local feature vector generating unit 41, a second local feature vector generating unit 42, and a third local feature vector generating unit 13.

The first local feature generating unit 41 projects an input face image onto an LFA basis vector for extracting a feature vector from the eye region, thereby generating a first local feature vector mainly reflecting the feature of the eye region. The second local feature generating unit 42 generates a second local feature vector focused on the nose region, and the third local feature generating unit 43 generates a third local feature vector focused on the mouth region.

The holistic feature similarity calculating unit 50 calculates a similarity between the holistic feature vector of the input face image generated in the holistic feature vector generating unit 30 and the holistic feature vector of a training face image stored in the training face image storage unit 20.

The local feature similarity calculating unit 60 calculates a similarity between a local feature vector of the input face image generated in the local feature vector generating unit 40 and a local feature vector of a training face image stored in the training face image storage unit 20.

A first local feature similarity calculating unit 61 calculates a similarity between the first local feature vector of the input face image generated in the first local feature generating unit 41 and the first local feature of a training face image. Likewise, a second local feature similarity calculating unit 62 and a third local feature similarity calculating unit 63 calculate a similarity between the second local feature vectors and a similarity between the third local feature vectors, respectively.

A local feature similarity addition unit 64 adds the similarity values calculated by the first through third local feature similarity calculating units 61 through 63, according to weights determined by a weight selection unit 70, thereby calculating an integrated local similarity value.

The weight selection unit 70 divides a face region into predetermined regions, and places different weights on the divided regions, respectively. For example, when similarities between local feature vectors of the eye, nose, and mouth regions are calculated and the calculated similarities are added, a larger weight may be placed on the eye region, thereby obtaining an integrated similarity. A weight with respect to a local region of a face can be easily determined by using a user interface. The weight can reflect the preference of a user who wants to identify the degree of similarity between face images, and enables a similarity to be measured in a variety of ways.

Also, the weight selection unit 70 gives a predetermined weight to the similarity values calculated by the holistic feature similarity calculating unit 50 and the local feature similarity calculating unit 60 so that the calculated similarity values can be applied to a final similarity result. When a large weight is given to a similarity value between holistic feature vectors, the importance of the difference between local feature vectors becomes relatively lower in calculating a final similarity.

The final similarity calculating unit 80 adds the holistic feature similarity and the local feature similarity, respectively calculated by the holistic feature similarity calculating unit 50 and the local feature similarity calculating unit 60, according to the weights determined by the weight selection unit 70, and outputs the result of addition by using an output method, such as a display or voice transmission method.

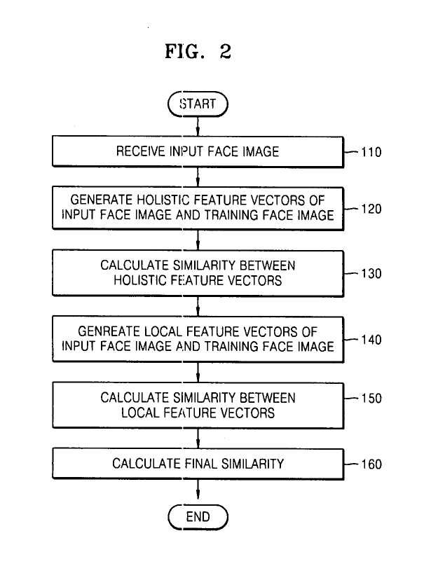

FIG. 2 is a flowchart of a method of calculating a similarity of a face image according to an embodiment of the present invention. The method of calculating a similarity of a face image according to the current embodiment includes the following operations performed sequentially in the apparatus 1 for calculating a similarity of a face image.

In operation 110, the reception unit 10 receives an input face image in order to calculate a similarity of the face image.

In operation 120, the holistic feature vector generating unit 40 projects the received input face image onto the first basis (PCA basis, that is, the eigenvector for the whole face region), thereby generating a holistic feature vector of the input face image, and projects one training face image selected from a set of training face images, onto the first basis, thereby generating a holistic feature vector of the selected training face image.

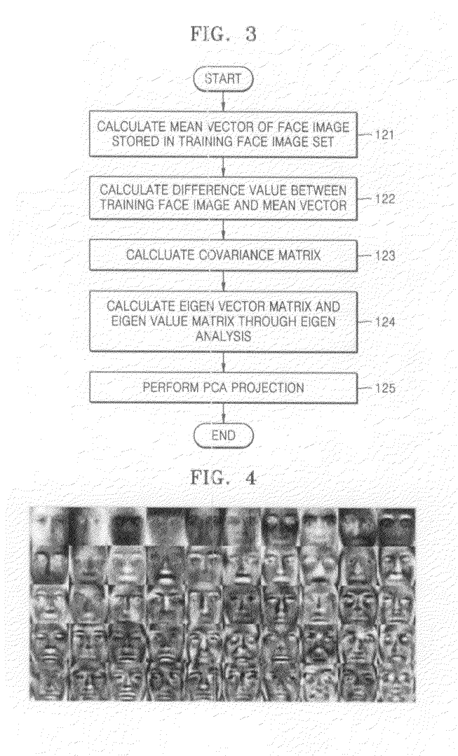

FIG. 3 is a detailed flowchart of operation 120 for generating a holistic feature vector illustrated in FIG. 2 according to an embodiment of the present invention. FIG. 3 illustrates in detail a method of calculating a PCA basis, and a method of generating holistic feature vectors from an input face image and a training face image. Unlike in the current embodiment, if PCA training is performed in advance with respect to all training face images included in a set of training face images, a separate operation for calculating a PCA basis is not necessary.

In operation 121, the basis generating unit (not shown) calculates the mean value of M training face images (φᵢ, i=1, . . . , M) stored in the training face image set to which the training face image belongs, according to equation 1 below.

m=(1/M)·Σᵢ₌₁^{M}φᵢ (1)

### Here, φᵢ is each training face image vector, and M is the number of training face images.

In operation 122, the basis generating unit (not shown) calculates the difference (xᵢ) between the training face image and the mean value according to equation 2 below.

xᵢ=φᵢ−m (2)

In operation 123, the basis generating unit calculates a covariance matrix according to equation 3 below by using a matrix, X=[x₁, . . . , x_{M}].

C=X·X^{T} (3)

In operation 124, the basis generating unit calculates an eigenvector matrix (U) and an eigenvalue matrix (A) according to equation 4 below.

C=U·Λ·U^{T} (4)

The eigenvector matrix (U) calculated according to equation 4 is used as a PCA basis for calculating a face similarity.

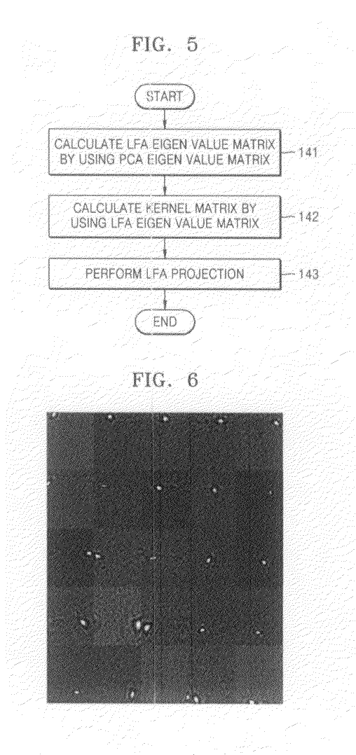

FIG. 4 is a diagram illustrating an example of a PCA basis according to the method illustrated in FIG. 3. In FIG. 4, the eigen face on the top left corner has the highest degree of dispersion, and the degree of dispersion of an eigen face decreases with the increasing distance from the left side or from the top side.

In operation 125, the basis generating unit (not shown) performs PCA projection according to equation 5 below, by using the eigenvector matrix (U), i.e., the PCA basis, generated in operation 124 and the mean vector (m) generated in operation 121.

y^{P}=U^{T}(φ−m) (5)

Here, φ is an input face image vector, and y^{P} is a holistic feature vector of the input face image. Likewise, the holistic feature vector of the training face image can be calculated by substituting a training face image vector for φ.

Referring back to FIG. 2, in operation 130, the holistic feature similarity calculating unit 60 calculates a similarity between the input face image and the training face image. The similarity between the holistic feature vectors can be calculated by using the cosine distance, the Euclidian distance, or the Mahalanobis distance between the holistic feature vectors. For example, a similarity can be calculated according to equation 6 below by using a weighted Euclidian distance.

$${S}_{H} ( {y}_{1}^{P} , {y}_{2}^{P} ) = {\sum }_{k = 1}^{n} {w}_{k}^{h} ‖ {y}_{1 , k}^{P} - {y}_{2 , k}^{P} ‖ \qquad ( 6 )$$

Here, y_{1,k}^{P} and y_{2,k}^{P} are holistic feature vectors of face images that are desired to be compared, k is the number of PCA bases that are selected in the order of higher eigen dispersion degree, and wₖ^{h} is a weight according to a preset holistic feature vector for calculating a similarity of a face.

In operation 140, the local feature vector generating unit 40 projects the received input face image onto the second basis (the LFA basis), thereby generating a local feature vector of the input face image. Also, the local feature vector generating unit 40 projects one training face image, selected from the training face image set, onto the second basis, thereby generating a local feature vector of the selected training face image. If a local feature vector of another local region is desired to be additionally generated, operation 140 further includes an operation for projecting each face image onto a third basis according to the other local region.

FIG. 5 is a detailed flowchart of operation 140 for generating a local feature vector illustrated in FIG. 2 according to an embodiment of the present invention. FIG. 5 includes an operation for calculating an LFA basis and illustrates in detail a method of generating holistic feature vectors from the input face image and the training face image. FIG. 2 does not illustrate an operation for generating the LFA basis (the second basis). If the LFA training is performed in advance with respect to all training face images included in the training face image set, the operation for calculating the LFA basis is not necessary.

Referring to FIG. 5, in operation 141, the basis generating unit (not shown) calculates an LFA eigenvalue matrix from the eigen matrix (A) calculated in operation 124, according to equation 7 or 8 below.

V=Λ^{-1/2}=diag(1/\sqrt{λᵢ}) (7)

### Here, λᵢ is each eigenvalue component forming an eigenvalue matrix Λ, and diag( ) is a diagonal matrix function.

V̅=diag(Fᵢ/\sqrt{λᵢ}) (8)

### Here, Fᵢ=λᵢ/(λᵢ+n²), and n is a parameter of a low pass filter (Fᵢ) set for removing noise.

In operation 142, a kernel matrix (K, K̅) is calculated according to equation 9 below, by using the eigenvector matrix (U) generated in operation 124 and the eigenvalue matrix (V, V̅) generated in operation 141.

K̅=U· V̅·U^{T}, K=U·V·U^{T} (9)

The kernel matrix is used as the LFA basis for calculating a similarity based on a local feature of a face image in the current embodiment.

FIG. 6 is a diagram illustrating an example of the LFA basis according to the method illustrated in FIG. 5. The dark parts are regions of low importance in the calculation of a similarity and the bright parts are regions of high importance.

Referring back to FIG. 5, in operation 143, the basis generating unit (not shown) performs LFA projection according to equation 10 below, by using the kernel matrix, i.e., the LFA basis, generated in operation 142 and the mean vector (m) generated in operation 121.

y^{L}= K̅^{T}(φ−m), y^{L}=K^{T}(φ−m) (10)

Here, φ is the input face image vector, and y^{L} is a local feature vector of the input face image. Likewise, the local feature vector of the training face image can be calculated, by substituting the training face image vector for φ.

In operation 150, the local feature similarity calculating unit 70 calculates a similarity between the local feature vectors of the input face image and the training face image. If a plurality of local feature vectors is extracted from a face image, for example, if the local feature vector respectively, of eyes, nose, and mouth, is extracted, the local feature similarity is separately calculated in relation to each region, and added together according to predetermined weights given by the weight selection unit 70.

A similarity between local feature vectors extracted from the local regions, i.e., eye, nose, and mouth regions, can be calculated by using the Euclidian distance function of equation 11 below.

$${{S}_{L} ( {y}_{1}^{L} , {y}_{2}^{L} )}_{i , j ∈ region} = {\sum }_{i , j ∈ region} w ( i , j ) ‖ {y}_{1}^{L} ( i , j ) - {y}_{2}^{L} ( i , j ) ‖ \qquad ( 11 )$$

### Here, (i,j) is image coordinates belonging to a predetermined region.

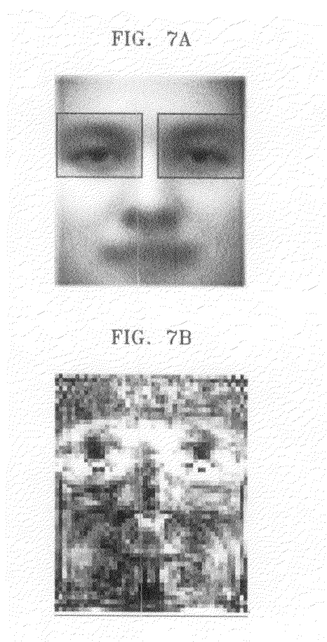

FIG. 7A is a diagram illustrating an example in which the eye region in a face image is selected as a local region, and FIG. 7B illustrates an example of weights with respect to each pixel according to an embodiment of the present invention.

In FIG. 7A, the regions in the boxes are the local eye regions. In equation 11, (i,j) indicates the image coordinates belonging to the regions in the boxes. A similarity of a local feature vector can be expressed by the Euclidian distance between y₁^{L}(i,j) and y₂^{L}(i,j) that are the local region feature values with respect to each image coordinates. When the similarity of this local image is obtained, a preset region weight w, which can be obtained by using equation 12 below, can be used.

$${σ}_{within} = {\sum }_{j} {\sum }_{i} {( {ϕ}_{ij} - {\overline{ϕ}}_{j} )}^{2} \qquad ( 12 )$$

In equation 12, the sum of dispersions with respect to changes in the face of one person, i.e., the sum of dispersions with respect to changes of face images belonging to each class, is calculated in each pixel.

Here, φᵢⱼ is an i-th image of a j-th person, and φ̅ⱼ is the mean face image of the j-th person. The thus obtained dispersion degree of each pixel is illustrated in FIG. 7B. FIG. 7B illustrates an example of weights with respect to local regions, in which a bright color indicates a low dispersion degree in the image of the identical person, and a dark color indicates a high dispersion degree. The high dispersion degree means that even in the photos of the identical person the pixel value changes greatly with respect to facial expression or pose changes. Accordingly, the weight wₖ has the same meaning as that of 1/σ_{within}.

A function for integrating local feature similarities in consideration of weights with respect to local regions is as equation 13 below.

S̅_̅{̅L̅}̅=Σwₖ^{l}S_{L} (13)

Here, wₖ^{l} is a final weight with respect to a local region l. This value can be set to a different value according to the intention of a user or an application.

In operation 160, the final similarity calculating unit 70 adds the similarity value of the holistic feature vector calculated in operation 130 and the similarity value of the local feature vector calculated in operation 150 so that the similarity values can be added according to predetermined weights given by the weight selection unit 30 as equation 14 below:

S̅_̅{̅T̅}̅=w_{H}S_{H}+w_{L}S_{L} (14)

### Here, w_{H} is a weight for the similarity between holistic feature vectors and, w_{L} is a weight for the similarity between local feature vectors.

A method and apparatus for retrieving a face image according to the present invention will now be explained in detail with reference to drawings and embodiments.

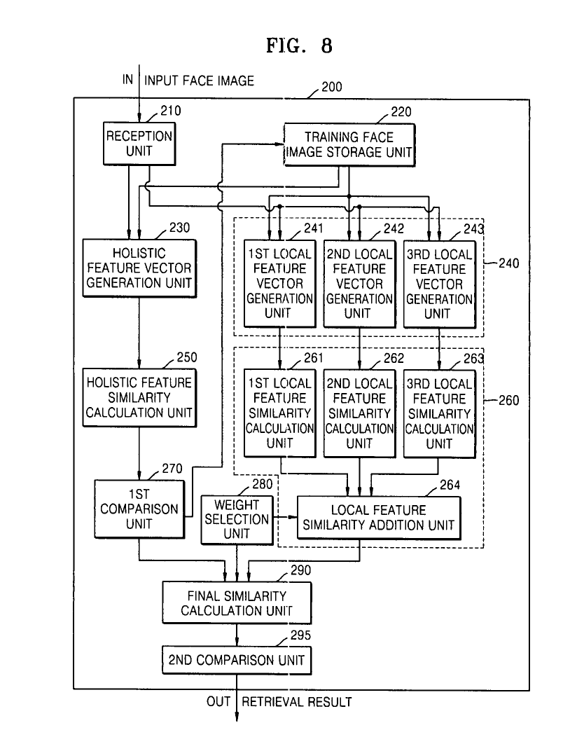

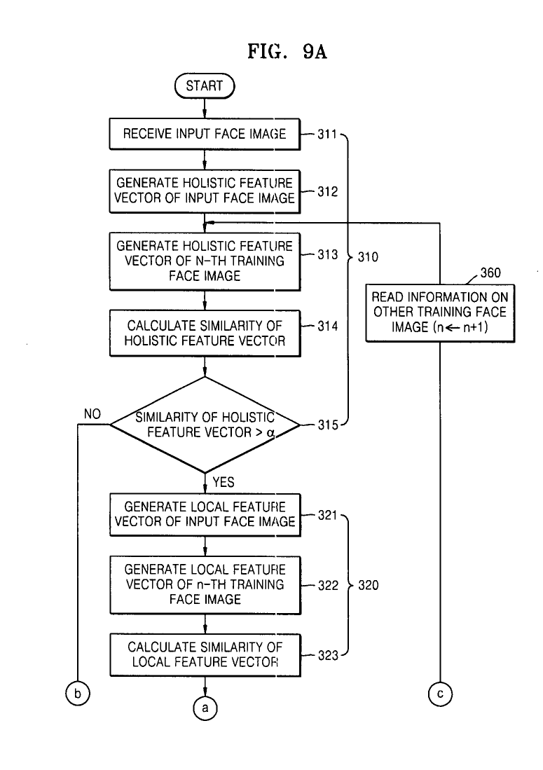

FIG. 8 is a block diagram illustrating an apparatus for retrieving a face image according to an embodiment of the present invention.

The apparatus 200 for retrieving a face image according to the current embodiment is composed of a reception unit 210, a training face image storage unit 220, a holistic feature vector generating unit 230, a local feature vector generating unit 240, a holistic feature similarity calculating unit 250, a local feature similarity calculating unit 260, a first comparison unit 270, a weight selection unit 280, a final similarity calculating unit 290, and a second comparison unit 295. Since the apparatus 200 for retrieving a face image has many elements common to those of the apparatus 1 for calculating a similarity of a face image, as illustrated in FIG. 1, detailed descriptions of the common elements will be omitted here.

The reception unit 210 receives information on a face image that is desired to be retrieved.

The training face image storage unit 220 stores a plurality of training face images. Retrieval of a face image is performed with the training face images stored in the training face image storage unit 20.

The holistic feature vector generating unit 230 projects each of the input face image and a training face image onto a PCA basis, thereby generating a holistic feature vector of the face image. The holistic feature similarity calculating unit 250 calculates a similarity between the holistic feature vectors generated in the holistic feature vector generating unit 230.

The first comparison unit 270 compares the similarity with a predetermined reference value. If the comparison result indicates that the similarity is greater than the predetermined reference value, the local feature vector generating unit 240 generates local feature vectors of the input face image and the training face image. If the similarity is less than the predetermined reference value, it means that the dissimilarity between the current training face image and the input face image is high. In this case, a local feature vector of the current training face image is unnecessary. Accordingly, according to the determination result of the first comparison unit 270, the training face image storage unit 220 transfers data of another training face image to the holistic feature vector generating unit 230. Then, in a following process, the holistic feature vector generating unit 230 generates a holistic feature vector of the new training face image, calculates a similarity, and compares the similarity with the predetermined reference value. In the current embodiment, the holistic feature vector generating unit 230, the holistic feature similarity calculating unit 250, and the first comparison unit 270 perform the processes until similarities with respect to all training face images stored in the training image storage unit are determined.

The local feature vector generating unit 240 projects each of the input face image and the training face image onto an LFA basis, thereby generating the local feature vector of the face image. A first local feature vector generating unit 241 extracts a first local feature vector from a region centered at the eyes, a second local feature vector generating unit 242 extracts a second local feature vector from a region centered at the nose, and a third local feature vector generating unit 243 extracts a third local feature vector from a region centered at the mouth.

First through third local feature similarity calculating units 261 through 263 calculate similarities between local feature vectors extracted from the input face image and the training face image and generated in the first through third local feature vector generating units 241 through 243, respectively.

A local feature similarity addition unit 264 adds the calculated similarity values according to predetermined weights determined by the weight selection unit 280.

The final similarity calculating unit 290 adds the similarity values of the holistic feature and the local feature according to predetermined weights.

The second comparison unit 295 compares the final similarity value with a predetermined reference value, and if the final similarity value is greater than the reference value, outputs the current training face image as the retrieval result.

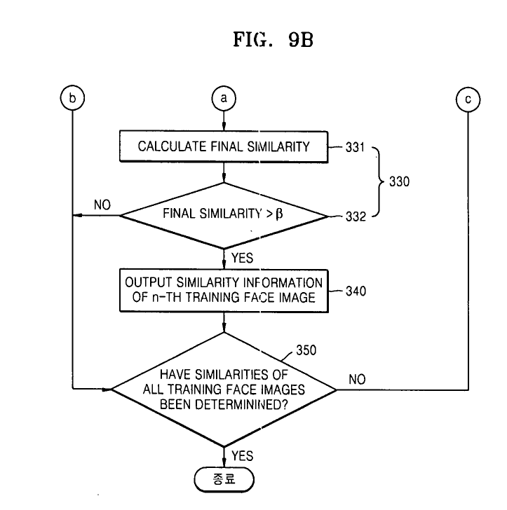

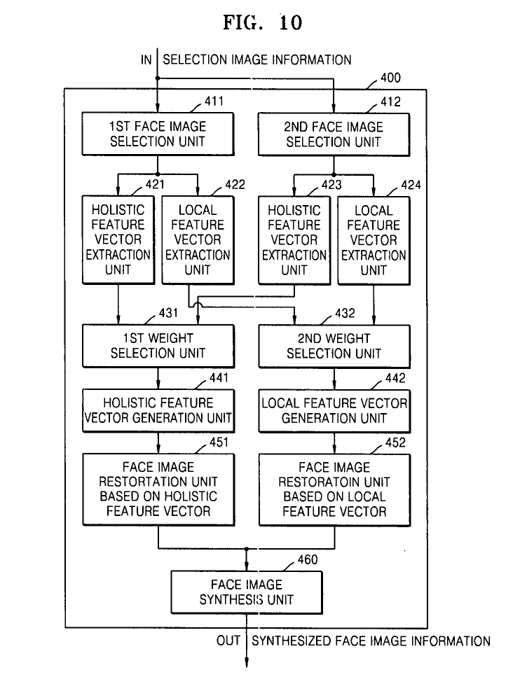

FIGS. 9A and 9B are a flowchart of a method of retrieving a face image according to an embodiment of the present invention. The method of retrieving a face image according to the current embodiment includes the following operations performed sequentially in the apparatus 200 for retrieving a face image.

Operation 310 includes operations 311 through 315 in which an input face image is received and the holistic similarity between the received input face image and a training face image stored in the training face image storage unit 220 is calculated.

In operation 311, the reception unit 210 receives information on the input face image that is desired to be retrieved.

In operation 312, the holistic feature vector generating unit 230 projects the received input face image onto a PCA basis, thereby generating a holistic feature vector of the input face image.

In operation 313, the holistic feature vector generating unit 230 projects a training face image onto the PCA basis, thereby generating a holistic feature vector of the (n-th) training face image. Here, the (n-th) training face image is one training face image selected from a training face image set, and indicates the current training face image whose similarity to the input face image is being determined.

In operation 314, the holistic feature similarity calculating unit 250 calculates a similarity between the input face image and the training face image.

In operation 315, the first comparison unit 270 compares the similarity value of the holistic feature vector with a predetermined reference value in order to determine whether or not the similarity value is greater than the predetermined reference value. If the determination result indicates that the similarity value is greater than the predetermined reference value, next operations (operations 320, 330, etc.) are performed. If the similarity value is less than the predetermined reference value, operation 350 for determining whether or not similarities of all training face images are determined and operation 360 for fetching a next ((n+1)-th) training face image from the training face image storage unit 220 are performed. The holistic feature generating unit 230 projects the training face image fetched in operation 360, onto the PCA basis, thereby generating a holistic feature vector.

Operation 320 includes operations 321 through 323 in which a local similarity between the received input face image and the training face image stored in the training face image storage unit 220 is calculated.

In operation 321, the local feature vector generating unit 240 projects the input face image onto an LFA basis, thereby generating a local feature vector of the input face image. The local feature vector generating unit 240 according to the current embodiment includes the first through third local feature generating units 241 through 243, and generates local feature vectors from the eye, nose, and mouth regions in the same manner as the local feature generating unit 40 illustrated in FIG. 1.

In operation 322, the local feature vector generating unit 240 projects the training face image onto the LFA basis, thereby generating a local feature vector of the training face image.

In operation 323, the local feature similarity calculating unit 260 calculates a similarity between the local feature vectors extracted from the input face image and the training face image. The local similarity calculating unit 260 of the current embodiment includes the first through third local feature similarity calculating units 261 through 263, and the similarity addition unit 264 which adds the similarity values between the local features according to the weights determined by the weight selection unit 280.

Operation 330 includes operations 331 and 332 in which a final similarity is calculated and the calculated final similarity is compared with a predetermined reference value.

In operation 331, the final similarity calculating unit 290 adds the similarity between the holistic feature vectors calculated in operation 315 and the similarity between the local feature vectors calculated in operation 323 according to weights according to the weight selection unit 280.

In operation 332, the second comparison unit 295 compares the final similarity value with the predetermined reference value.

If the determination result indicates that the similarity value is greater than the predetermined reference value, the current training face image is output as the retrieval result.

In operation 340, a result output unit (not shown) displays the current training face image and information on the similarity result to the user.

In operation 350, the second comparison unit 295 determines whether or not similarities of all training face images are determined. If a training face image whose similarity is not determined does not exist, the current process is finished.

In operation 360, the holistic feature vector generating unit 230 reads data on another training face image ((n+1)-th training face image) from the training face image storage unit 220. Operations 313 through 350 are performed again, and this process is repeated until similarities between all training face images and the input face image are calculated.

A method and apparatus for synthesizing a face image according to the present invention will now be explained in detail with reference to drawings and embodiments.

FIG. 10 is a block diagram illustrating an apparatus for synthesizing a face image according to an embodiment of the present invention. The apparatus 400 for synthesizing a face image according to the current embodiment is composed of a first face image selection unit 411, a second face image selection unit 412, holistic feature extracting units 421 and 423, local feature extracting units 422 and 424, a first weight selection unit 431, a second weight selection unit 432, a holistic feature vector generating unit 441, a local feature vector selection unit 442, a face image restoration unit 451 based on a holistic feature vector, a face image restoration unit 452 based on a local feature vector, and a face image synthesizing unit 460.

The first face image selection unit 411 and the second face image selection unit 412 receive information on two face images from a user interface.

The holistic feature vector extracting unit 421 extracts a holistic feature vector from the first face image, and the holistic feature vector extracting unit 422 extracts a holistic feature vector from the second face image. Although the current embodiment includes the units for extracting feature vectors from a selected face image, if PCA training and LFA training are performed in advance with respect to training face images and a DB based on the result is established, a separate feature vector extracting unit is not necessary.

The first weight selection unit 431 gives predetermined weights to the holistic feature vectors extracted from the holistic feature vector extracting units 421 and 423. Here, the predetermined weights reflect the importance of the first face image and the second face image in a synthesized face image that will be the final result, and can be adjusted in a variety of ways according to the preference of the user.

The holistic feature vector generating unit 441 adds the holistic feature vectors of the first face image and the second face image according to the weights.

The face image restoration unit 451 based on a holistic feature vector restores a face image vector (φ) by using the added holistic feature vector value and equation 6.

Likewise, the second weight selection unit 431 places predetermined weights on the local feature vectors extracted in the local feature vector extracting units 422 and 424. The local feature vector generating unit 442 adds the local feature vectors of the first face image and the second face image according to the weights. The face image restoration unit 452 based on a local feature vector restores a face image vector (φ) by using the added local feature vector value and equation 10.

The face image synthesizing unit 460 adds the face image vectors restored in the face image restoration units 451 and 452.

Although it is not shown in FIG. 10, the face image vector added in the face image synthesizing unit 460 may be converted into a signal form that can be visually recognized by the user, and the signal may be displayed by a display unit (not shown).

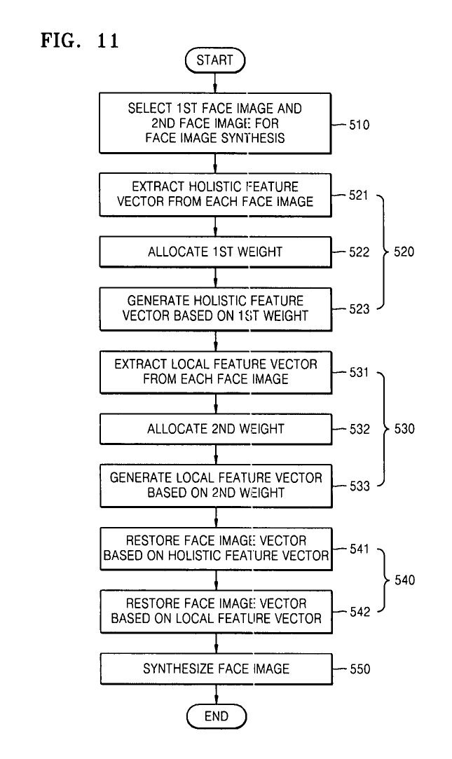

FIG. 11 is a flowchart of a method of synthesizing a face image according to an embodiment of the present invention.

The method of synthesizing a face image according to the current embodiment includes the following operations performed sequentially in the apparatus 400 for synthesizing a face image.

In operation 510, the first face image selection unit 411 and the second face image selection unit 412 select two face images for synthesizing a face image.

In operation 520, a holistic feature vector based on a combination of the first face image and the second face image is generated. In operation 521, holistic feature vectors are generated from the first face image and the second face image. In operation 522, a weight is given to each of the holistic feature vectors. In operation 523, the holistic feature vectors are added according to predetermined weights, thereby generating a new holistic feature vector.

In operation 530, a local feature vector based on a combination of the first face image and the second face image is generated.

In operation 531, local feature vectors are generated from the first face image and the second face image. In operation 532, a weight is given to each of the local feature vectors. In operation 533, the local feature vectors are added according to predetermined weights, thereby generating a new local feature vector.

In operation 540, the face image restoration units 451 and 452 restore face image vectors by using the holistic feature vector and the local feature vector generated in operations 520 and 530, respectively.

Finally, in operation 550, the face image synthesizing unit 460 adds the face image vectors restored in the face image restoration units 451 and 452, respectively.

Although it is not shown in FIG. 11, an operation, in which the added face image vector is displayed so that the user can visually recognize the result, may be further included.

Although it is not shown in the attached drawings, the method of calculating a similarity of a face image, the method of retrieving a similar image, and the method of synthesizing a face image can be implemented in a mobile terminal because the complexity of the methods is low.

In particular, by establishing in advance a DB of holistic feature vectors and local feature vectors extracted by preliminary training of training face images, the calculation speed of a similarity of a face image can be improved.

Also, the present invention can be implemented as a system for retrieving a similar face, the system including a mobile terminal performing only reception of an input face image or input of a weight, a separate server providing a service for determining a similarity of a face image, and a DB of training face images established in the server side.

According to the present invention, by separately calculating a holistic similarity of a face image based on the holistic feature of the face image, and a local similarity of a face image based on the local features of the face image, and adding the calculated similarity results according to weights, thereby calculating the similarity between compared face images, the similarity calculation result of the face considering both the holistic feature and local features of the face image can be obtained, thereby improving reliability of the face image similarity calculation and lowering the complexity of calculation.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of calculating a similarity of a face image, comprising:
projecting an input face image onto a first basis related to the whole region of a face extracted from a training face image set, and generating a holistic feature vector of the input face image;
projecting the input face image onto a second basis related to a local region of a face extracted from the training face image set, and generating a local feature vector of the input face image; and
calculating a similarity between a training face image selected from the training face image set and the input face image, by using the holistic feature vector and the local feature vector of the training face image and the generated holistic feature vector and local feature vector of the input face image.

2. The method of claim 1, wherein the calculating of the similarity comprises:
calculating a similarity between the holistic feature vector of the training face image selected from the training face image set and the holistic feature vector of the input face image;
calculating a similarity between the local feature vector of the selected training face image and the local feature vector of the input face image; and
giving predetermined weights to the calculated similarities and calculating a similarity between the selected training face image and the input face image.

3. The method of claim 1, wherein the first basis is generated by performing PCA (principal components analysis) on the training face image set.

4. The method of claim 1, wherein the second basis is generated by performing LFA (local feature analysis) on the training face image set.

5. The method of claim 3, wherein the performing of the PCA comprises:
calculating a mean vector of face images based on the training face image set;
generating a matrix based on differences between training face image vectors belonging to the training face image set and the mean vector of face images;
generating a covariance matrix of the generated matrix; and
generating an eigenvector matrix, by performing eigen analysis on the generated covariance matrix,
and the first basis is the eigenvector matrix.

6. The method of claim 5, wherein the performing of the LFA comprises:
further generating eigenvalues of the generated covariance matrix;
generating a low-pass matrix according to a first local region, by using the generated eigenvalues; and
generating a second basis, by using the generated low-pass matrix and the first basis vector.

7. The method of claim 6, wherein the low-pass matrix and the second basis are generated according to the following equations, respectively:
V̅=diag(Fᵢ/\sqrt{λᵢ})
K̅=U· V̅·U^{T}
where V̅ is a low-pass matrix, Fᵢ=λᵢ/(λᵢ+n²), λᵢ is an eigenvalue according to the covariance matrix, n is a width constant of a low-pass filter, U is the first basis matrix, and K̅ is the second basis matrix.

8. The method of claim 1, further comprising generating a low-pass matrix according to a second local region that is not the same as the predetermined local region, by using the generated eigenvalue, and generating a third basis by using the generated low-pass matrix,
wherein the projecting of the input face image onto the second basis and the generating of the local feature vector of the input face image further comprises projecting the input face image onto the third basis, thereby generating the local feature vector of the input face image, and in the calculating of the similarity between the training face image and the input face image, the local feature vector generated by projecting the input face image onto the third basis, and the local feature vector generated by projecting the training face image are further used.

9. The method of claim 2, wherein the second basis comprises a plurality of local bases in relation to two or more local regions, and
in the calculating of the similarity between the local feature vector of the selected training face image and the local feature vector of the input face image, the similarity between the local feature vectors is calculated by further considering a predetermined weight according to the local region.

10. The method of claim 4, wherein normalization of the input face image and the selected training face image comprises:
filtering a face image by using a Gaussian low-pass filter;
identifying the eye region in the filtered face image;
normalizing the face image based on the eye region; and
changing illumination in order to remove dispersion of the illumination.

11. A computer readable recording medium having embodied thereon a computer program for executing the method of calculating a similarity of a face image of claim 1.

12. A method of calculating a similarity of a face image comprising:
extracting a first basis related to the whole region of a face from a training face image set;
extracting a second basis related to a local region of a face from the training face image set;
projecting an input face image onto the first basis, thereby generating a holistic feature vector of the input face image;
projecting the input face image onto the second basis, thereby generating a local feature vector of the input face image;
projecting any one training face image selected from the training face image set, onto the first basis, thereby generating a local feature vector of the selected training face image;
projecting the selected training face image onto the second basis, thereby generating a local feature vector of the selected training face image;
comparing the holistic feature vector of the input face image with the holistic feature vector of the selected training face image;
comparing the local feature vector of the input face image with the local feature vector of the selected training face image; and
calculating a similarity between the input face image and the selected training face image, by using the comparison results.

13. An apparatus for calculating a similarity of a face image, comprising:
a reception unit receiving an input face image;
a holistic feature generating unit projecting the input face image onto a first basis related to the whole region of a face extracted from a training face image set, and generating a holistic feature vector of the input face image;
a local feature generating unit projecting the input face image onto a second basis related to a local region of a face extracted from the training face image set, and generating a local feature vector of the input face image; and
a similarity calculating unit calculating a similarity between a training face image selected from the training face image set and the input face image, by using the holistic feature vector and the local feature vector of the training face image and the generated holistic feature vector and local feature vector of the input face image.

14. The apparatus of claim 13, further comprising a PCA basis generating unit generating the first basis by performing PCA on the training face image set.

15. The apparatus of claim 13, further comprising an LFA basis generating unit generating the second basis, by performing LFA on the training face image set.

16. The apparatus of claim 13, wherein the similarity calculating unit further comprises:
a first similarity calculating unit calculating a similarity between the holistic feature vector of the selected training face image and the holistic feature vector of the input face image; and
a second similarity calculating unit calculating a similarity between the local feature vector of the selected training face image and the local feature vector of the input face image, and
the similarity calculating unit calculating the similarity between the selected training face image and the input face image, by using the similarity values calculated in the first and second similarity calculating units.

17. A method of retrieving a face image comprising:
projecting an input face image onto a first basis related to the whole region of a face extracted from a training face image set, and generating a holistic feature vector of the input face image;
projecting the input face image onto a second basis related to a local region of a face extracted from the training face image set, and generating a local feature vector of the input face image; and
retrieving a face image from the training face image set, by using the generated holistic feature vector and local feature vector, the face image having a predetermined similarity with the input face image.

18. An apparatus for retrieving a face image comprising:
a holistic feature generating unit projecting an input face image onto a first basis related to the whole region of a face extracted from a training face image set, and generating a holistic feature vector of the input face image;
a local feature generating unit projecting the input face image onto a second basis related to a local region of a face extracted from the training face image set, and generating a local feature vector of the input face image; and
a retrieval unit retrieving a face image having a predetermined similarity with the input face image, from the training face image set, by using the holistic feature vector and the local feature vector of the input face image.

19. A method of synthesizing a face image comprising:
selecting two or more face images for synthesizing a face;
extracting a holistic feature vector and a local feature vector from each of the selected face images;
restoring a face image vector based on the holistic feature, by using the holistic feature vector extracted from each of the selected face images;
restoring a face image vector based on the local feature, by using the local feature vector extracted from each of the selected face images; and
synthesizing the restored face image vectors.
